(19) United States
(12) Patent Application Publication
(10) Pub. No.: US 2004/0233668 A1
(43) Pub. Date: Nov. 25, 2004

(54) Decorative string lights

(75) Inventors: Jennifer Telfer, Oceanside, CA (US); James B. Robertson, Aptos, CA (US); David P. Moriconi, Ben Lomond, CA (US); Temujin W. Kuechle, Santa Cruz, CA (US)

Correspondence Address: DONN K. HARMS, PATENT & TRADEMARK LAW CENTER, SUITE 100, 12702 VIA CORTINA, DEL MAR, CA, 92014, US

(73) Assignee: JENNIFER TELFER

(21) Appl. No.: 10/715,717

(22) Filed: Nov. 17, 2003

Related U.S. Application Data
(60) Provisional application No. 60/472,670, filed on May 21, 2003.

(51) Int. Cl. F21S 13/14

(52) U.S. Cl. 362/252

(57) ABSTRACT

A string of decorative string lights with a plurality of light fixtures that radiate light throughout each separate fixture joined by spacer beads that additionally catch and reflect the light given off by the LED's within each adjacent light fixture. The LED's are mounted in an inverted position in the unique socket assembly made of a translucent material to diffuse the concentrated light given off by the LED. Each socket is covered with a decorative globe to further diffuse light transmission. The light fixtures on the decorative string lights can be very small to be used as illuminated jewelry as well as larger for Christmas and advertising lighting

This application claims the benefit of U.S. Provisional Application No. 60/472,670 filed May 21, 2003. This invention relates to string lighting in which a plurality of lights provides illumination and receives power through an elongated power chord communicating with a power source, commonly called decorative light sets. More particularly it relates to decorative type lighting which conventionally is provided in long strings such as Christmas tree lights, Christmas house decoration lights, or strings of lights used in landscaping, decoration or other illuminated means of ornamentation. The device as disclosed replaces the incandescent or resistance style light bulbs used in conventional string lights with a novel component housing and a light emitting diode or other light source. Pluralities of such component housings are attached to the elongated electrical cabling providing power and thereby provide decorative or illuminating lighting in strings. These light strings may use conventional house current, low voltages through a transformer, or batteries.

### FIELD OF THE INVENTION

### BACKGROUND OF THE INVENTION

String lighting sets have long been used in the United States and throughout the world in a commercial atmosphere to provide illumination such as in car lots or for enhancing trees or the like at night. Such string lights are also used worldwide on Christmas trees and as decorative lighting on houses and businesses for festive periods and advertising.

Conventional string light sets suffer from a number of problems inherent to such lights. One such lighting problem arises when low voltage lights are used and strung in series. This type of lighting is done with mini-bulbs and uses a large number of small voltage bulbs which are then wired in series and add up to the total voltage applied to the power chord. Unfortunately, when wired in series, if one bulb breaks or comes lose or burns out, the whole string tends to cease providing light. With each bulb consuming a watt or so, the string lights do tend to consume a large amount of current when used with 120 volts.

Lights that are strung on a long chord in parallel, while not suffering from termination of illumination if one light fails, suffer from the fact that they all must be able to handle the higher voltage that is applied to the string when one or more lights are lost and thereby each light produces more heat and will not last as long. The heat buildup even from the smaller bulbs can be a significant factor and from the larger high voltage bulbs the heat and high current requirements consume excessive energy as well as causing cooling problems, premature failure and possibly a fire hazard.

References Cited

U.S. Pat. No. 4,675,575 of Elmer L. Smith describes a light string system that is provided having a plurality of mono-color or bi-color light-emitting diodes electrically connected thereto. Each light-emitting diode has a generally elongated, hollow envelope mounted thereover, and the envelope is substantially filled with light conducting optical spheres or even fragments. The envelope may be additionally filled with light-conducting epoxy, light-conducting liquid or light conducting gas and sealed for improved light transmission and dispersion characteristics. The light-emitting diodes may include an improved base with light-emitting diode leads disposed approximately perpendicular to the axis of the envelope for bulb stability and for enabling the bulb to stand upright on the branches. Both the envelope and the optical spheres include light-conducting glass or plastic material. The spheres may be either hollow or spherical and may be of a uniform or a mixed size. Additionally, the spheres may be large for stacking in single file within the envelope or centrifuged to the sides of the envelope with the center devoid of spheres.

This patent endeavors to solve the problem of the concentrated light source by defusing the light through the hollow envelope filled with light conducting optical spheres or fragments where the so disclosed patent s the light by inverting the LED and passing the light through the socket and decorative globe. This patent also does not have the unique current limit circuit.

U.S. Pat. No. 5,300,864 of Franklin J. Allen Jr. teaches of a programmable lighting control system for decorative, artistic, and Christmas lighting applications including a plurality of outlet receptacles for connection thereto of series or parallel connected Christmas tree lighting strings or the like, a plurality of associated output select switches to individually select a lighting condition signal for each respective outlet receptacle, timing and control circuitry to generate a plurality of lighting condition signals that are applied to solid-state switching devices to drive the outlet receptacles, an output timing phase synchronization feature initiated at user discretion to synchronize the timing phase of each of the plurality of lighting condition signals, and a memory function to retain the last programmed lighting display conditions of user-selected, entirely unique lighting patterns when using a plurality of lighting strings.

This patent uses a control circuitry to generate a plurality of lighting conditions, but does not specifically use LED's and does not incorporate the unique current limit circuit.

U.S. Pat. No. 5,313,187 of Robert S. Choi et al. discloses one or more super luminescent light emitting diodes (SLDS) that are driven with an oscillatory square wave pulse drive signal which produces a brilliant rapidly flashing light having high on-off contrast for enhanced visibility and perceptibility at a distance thus being usable for battery-powered visual indicator and warning flasher applications. The pulse on time and off time and thus the flash frequency and duty cycle are determined by RC time constants of feedback circuits in the oscillator stage and thus can be set by selecting appropriate component values.

This patent has been designed primarily for visual indicator and warning flasher applications and not for decorative illumination in any way.

U.S. Pat. No. 5,495,147 of Vincent A. Lanzisera additionally describes an LED light string system constructed according to teachings of the present invention comprised of a string of LED's and a regulated power supply. The string of LED's comprises a plurality of LED's interconnected in parallel. The regulated power supply provides a constant current and a constant voltage to the LED's. The LED light string system may be used for decorative, signaling and a variety of other applications.

This patent has the regulated power supply and uses LED's but does not incorporate the inverted LED within the unique socket for defusing the concentrated light source.

U.S. Pat. No. 6,265,834 of Mei-Lu Lin tells of a tubular string of Christmas lights that includes a transparent hose, an arcuate strip disposed into the hose having a pair of electrical wires integrated therein and a pair of inlets at each end, a plurality of Christmas lights disposed into the hose and alternately connected to the electrical wire through a pin with barb at the free end with a plug having a pair of blades at one end made engageable into the inlets of the electrical wires and a pair of sockets at the other end for engaging within the blades of an additional plug. The tubular string of the Christmas lights can be cut into different lengths to cope with the requirement of the user, and can be connected together by the plugs.

This patent for a tubular string of Christmas lights does not use LED's and does not incorporate the unique current limit circuit.

U.S. Pat. No. 6,344,716 by James W. Gibboney, Jr. describes an electrical circuit for use with plural, low voltage leads such as a string of Christmas lights, comprising groups of lights placed electrically in a series circuit, but the lights within each group are in parallel, preferably with a semiconductor device in parallel with each group to limit current and voltage in the group. By suitable choice of bulb, group size and number of groups, a light string can be fashioned that uses about one-third the power with much less heat production and without loss of brightness. The semiconductor device can consist essentially of diodes such as two silica diodes on either side of a Zeuer diode, or a custom bipolar device.

This patent describes an electrical circuit, but does not specify the use of LED's or use the unique light-diffusing socket within a decorative globe.

U.S. Pat. No. 6,461,019 (Allen) teaches a method and structure for placing LED's in series strings and then wiring the strings in parallel to yield a string of lights. However, Allen only addresses the issue of stringing sufficient lights to yield the correct voltage across the parallel AC line and lacks any teaching for mounting the lights in a carrier designed to evenly disperse light.

As such, none of the foregoing prior art teaches or suggests the particular device that will advance and refine the vast field of decorative illumination.

### SUMMARY OF THE INVENTION

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The new decorative string lights disclosed and described within this patent incorporate a unique current limit circuit that will deliver a fixed amount of power to a plurality of light fixtures, which are cooperatively engageable with Light Emitting “Diodes (LED) as their light source. LED's produce high intensity light at very low voltages with little heat build up and thereby solve many of the problems associated with string lights of the past. The device solves the problems of LED lighting that were conventionally hard wired, by providing a unique light fixture that engages over the wires providing power from a conventional power source. The disclosed device provides light fixtures with the LED's attached in a unique socket within the light fixtures that are located on the power cord. All the light fixtures attached to each power cord will have the power controlled by the current limit circuit with full power continuing on to the next set of decorative string lights if desired.

Also, the LED's may be inserted and removed from the socket for replacement and maintenance, which solves the problem of LED lights that are hardwired in conventional string lights.

Still further, each light fixture consists of a socket that acts as a light diffusion device for the LED, which is inserted in an inverted position into the socket. A decorative globe is removably attachable to the socket to surround the LED and socket providing a filter to color the light, protection to the LED, and an additional light diffuser to make the light from a very small LED illuminate the decorative globe.

The device also offers a unique spacer bead, which may be located between the decorative globes to catch and disburse light to the viewer while further enhancing the light projection capabilities of the device.

The current limit circuit, used on the device when powered by A.C. current, delivers the fixed amount of power to the LED's and has two modes of operation. The first mode is the charging of a storage device, in this case a capacitor labeled C1. The second mode is the delivering of a fixed amount of power to the LED's. AC current reverses the voltage on two wires each half cycle, therefore the voltage at J3 alternates with respect to J1, being positive during one half cycle (first mode) and negative during the other half cycle (second mode).

The operation during the first mode is very simple. The diode D6 conducts current as soon as the voltage rises above about 0.6V. The current increases through R4 and charges C1 to a voltage limited by D9. Therefore D9 establishes the amount of power stored on C1.

The operation during the second mode is a little more complex. When the voltage on J1 is positive enough to exceed the voltage drop required by the LED devices to allow them to conduct, the current limit comes into play. Because the voltage established on C1 is present, it turns on Q1. The current flows through Q1 and R1 to the LED chain. As the current increases the voltage drop increases across R1. This voltage drop allows R3 to discharge C1. The amount of discharge is determined by the amount of power being applied to the LED's. When the power stored on C1 has been drained off by R3 enough Q1 stops conducting.

The attached drawings depict a number of preferred embodiments of the device and the components thereof. While the present invention has been described herein with reference to particular embodiments thereof, and shown in some preferred embodiments in the drawings attached hereto, a latitude of modifications, various changes and substitutions are intended in the foregoing disclosure, and will be appreciated that in some instance some features of the invention will be employed without a corresponding use of other features without departing from the scope of the invention as herein disclosed.

An object of this invention is to create a set of decorative string lights that are uniquely different in appearance from existing string lights.

Another object of this invention is to create a set of decorative string lights that use less electricity and last longer and are safer than conventional string lights.

An additional object of this invention is to create a set of decorative lights that use LED's for illumination instead of the conventional incandescent bulbs.

A further object of this invention is to create a set of decorative string lights that use LED's in an inverted position and are diffused through the translucent socket, so as not to create a hot spot on the decorative enclosures.

Yet another object of this invention is to create a set of decorative string lights that have the capability of having many more light elements on each string along with reflective members between each light element.

A further object of this invention is to create a set of decorative string lights that have replaceable LED's.

A still further object of this invention is to create a set of decorative string lights that, with a current limit system, will deliver a controlled amount of power to the LED's within each decorative string light set.

It is another object of this invention to create a set of decorative string lights that can be made as small as jewelry or as large as desired.

A final object of this invention is to advance and refine the vast field of decorative illumination. These together with other objects of the invention along with the various features of novelty which characterize the invention are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a perspective drawing of the decorative string light set.

FIG. 2 depicts an exploded perspective view of a single light fixture and central socket unit with a spacer bead.

FIG. 3 depicts an exploded perspective view of a single light fixture with the central socket unit assembled.

FIG. 4 is schematic of a cycle by cycle power control circuit which meters the total electrical power communicated to the LED's wired in series in the decorative light string.

### DETAILED DESCRIPTION OF THE PREFERRED EMBODIMENTS

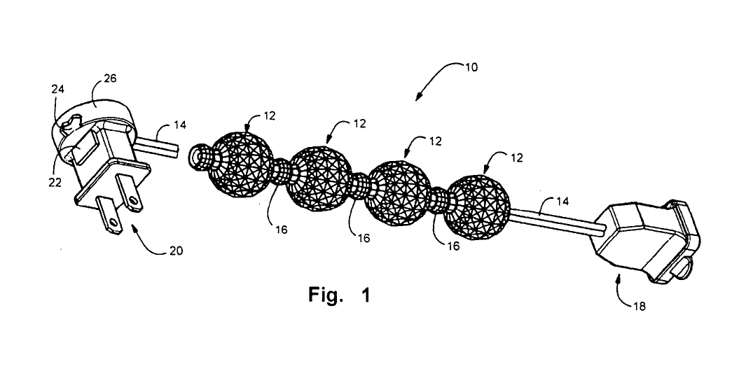

Referring now to the drawings, wherein similar parts of the invention are identified by like reference numerals, there is seen in FIG. 1 a preferred embodiment of the herein disclosed decorative string lights device 10 consisting of a plurality of light fixtures 12 operatively attached to a power cord 14. In a preferred mode of the device 10 the individual light fixtures are separated by one or more spacer beads 16 which during operation will generally absorb and transmit refracted light from adjacent light fixtures 12.

The power cord 14 will have a single AC female plug 18 at one distal end, with a single male plug 20 located at the opposite end. The depicted female plug 18 and male plug 20 are shown as the type used in the United States and those skilled in the art will realize that Europe and many individual countries throughout the world have different plug configurations. Such differing plug configurations are anticipated within the scope of this patent and any plug configuration adapted to operatively engage and transmit the AC power supply down the power cord 14 will work.

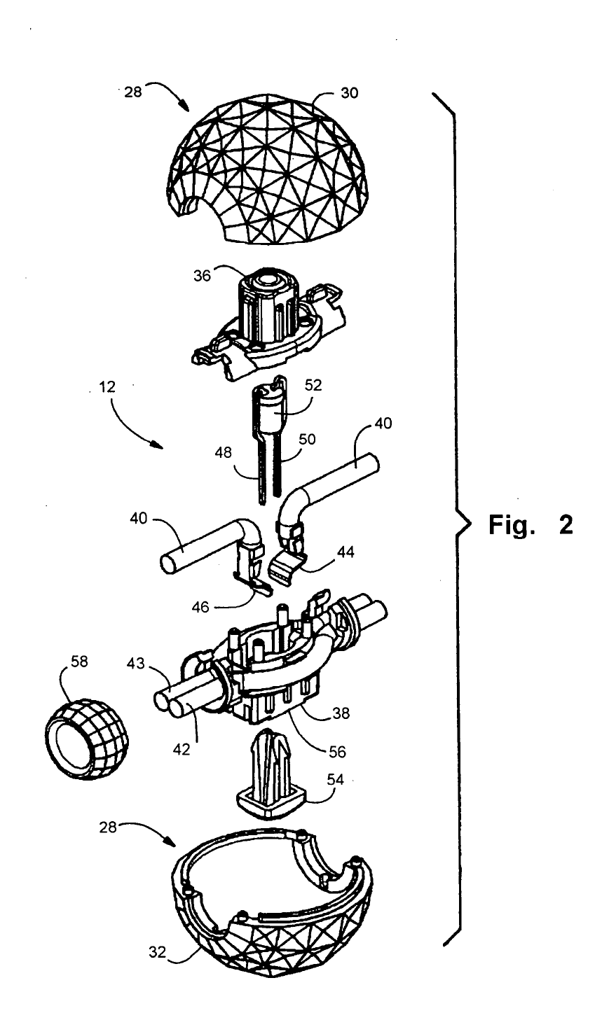

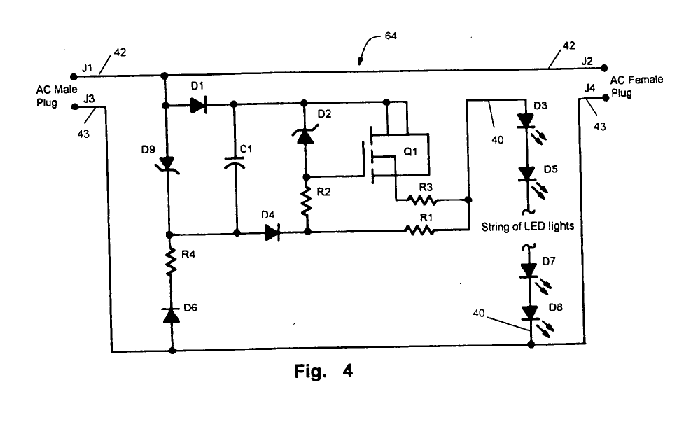

The AC male plug 20 in the current best mode of the device 10 will provide a fuse housing 22 along with the current limit circuitry 24 under the cover 26. As depicted in FIG. 1 the power cord 14 has two wires which would be the simplest form of power chord 14 if only one string is formed. However, if numbers of strings of lights are to be hooked together as is done on Christmas trees and outdoor lighting, a preferred mode of the device would have a contiguous wire 42 and common wire 43 as shown in FIG. 2 which would be a direct AC link between the male plug 20 and female plug 18 limited by the control circuit 24 shown in FIG. 4. Also as shown in FIG. 2, both the contiguous wire 42 and common wire 43 pass around the sides of the socket assembly 34 which it has been found further enhances the elimination of dark spots in the finally working assembly, especially with the use of the inverted LED 52. The control circuit 24 would meter or control the power transmitted on interconnecting wire 40 only. This third or interconnecting wire 40 would thus provide metered AC current to the light fixtures 12 on the individual string and additional strings plugged into each female plug 20 downline would not be subject to the control circuit 24 in the preceding string which would only meter the power in the interconnecting wire 40 in its own string.

Each light fixture 12 of one current preferred embodiment of the device 10, as best illustrated in FIG. 2, will consist of a decorative casing 28, which in the current preferred mode of the device 10 is formed by two faceted halves 30 and 32 of a formed sphere that cooperatively engage together to enclose the internal parts and form the casing 28. The casing 28 in a preferred mode of the device is faceted and forms substantially a glob shaped Fresnel lens to dissipate the light from each light fixture 12 at a large number of different angles. It must be understood that the decorative casing 28 is depicted as spherical in shape; however, it is anticipated that the casing 28 could be provided in a wide variety of geometric and decorative shapes depending on the decorative task at hand. The casing 28 could also be formed into animal or festive or religious icon shapes and any of a myriad of shapes to fit the occasion in which the device 10 will be used. Also, the sizes can vary and they may be made of one or a plurality of pieces and in a wide range of colors to enclose the internal parts and disperse externally, the light generated internally, and still remain within the scope of this patent.

The socket assembly 34 which is encased in the decorative casing 28, consists of an upper section 36 and a lower section 38 and engages and operatively mounts upon the interconnecting wire 40 and the contiguous wire 42 and ground wire 43. In its simplest form, the device 10 would function without the upper section 36 and such is anticipated; however, better diffusion of light and protection of the LED 52 or other means for light generation is achieved using the upper section 36. Also in a simpler embodiment than depicted, the decorative casing 28 could be left off if both the upper section 36 and lower section 38 are engaged and surround the means for light generation from AC power which in the current best mode is an LED 52. In this fashion, light would be diffused only by the formed socket assembly 34 which instead of being substantially clear or transparent as when using the casing 28, would be translucent or faceted to better diffuse the light.

The circuit formed by the interconnecting wire 40 is broken at each socket assembly 34 with contacts 44 and 46 attached at the ends. Contacts 44 and 46 when assembled provided a means for cooperative electrical engagement with the means for light generation from AC power using the connection with the leads 48 and 50 of the current best such means for light generation in the form of LED 52. As depicted in FIG. 2, in the current best mode of the disclosed device 10, the LED 52 is inverted in its mount inside the transparent or translucent socket assembly 34. During experimentation in arriving at the current preferred embodiment of the device 10, hot spots or bright spots with corresponding dark spots being projected from the decorative casing 28 caused a constant problem. Unexpectedly, after attempts at diffusion and means to rid the decorative casing 28 of the dark and bright spots, the LED was inverted into the socket assembly 34 and unexpectedly substantially eliminated the hot spots and the dull or dark spots from the mounted decorative casing 28 which emitted an even glow from all angles. Consequently, inverted mounting of the LED 52, accomplished by running the conventional leads 48 and 50 down from a top side engagement to the contacts 44 and 46, is extremely important and provides great visual enhancement to the even light transmission of the device 10. Since the LED 52 is inverted into a substantially centered position inside the socket assembly 34, the socket assembly acts as a diffuser of the generated light. Also, using substantially transparent or translucent material to form both the upper section 36 and lower section 38 light is evenly transmitted through the walls forming the top, bottom, and sides of the socket assembly 34 and eliminates the dark spot that occurs if the LED 52 or other means for light generation were mounted upright in a conventional non transparent socket assembly or even in the disclosed socket assembly 34. The inverted positioning of the LED 52 or other means for light generation inside a transparent or translucent socket assembly 34 significantly increases the even distribution of light and overall appearance of the device 10 when deployed for decoration. Also, when used with the surrounding decorative casing 28 a very even and pleasing light is transmitted from the decorative casing 28 due to the even light transmission provided by the inverted mount inside the translucent or transparent socket assembly 34 which also acts as a diffuser.

In the depicted device 10 as best shown in FIG. 2, a transparent or translucent locking plug 54 is inserted at the base 56 of the lower section 38 to lock the contacts 46 and 44 in place with the respective leads 48 and 50 feeding electrical power to the LED 52 or other means for light generation that would use electrical power provided by the interconnecting wire 40. The locking plug 54 would thus form a portion of the wall of lower section 38 when the socket assembly 34 is fully assembled and is thus also transparent or translucent and of the same material as the lower section 38. The upper section 36 and the lower section 38 of the socket assembly 34 readily snap together and apart for easy replacement of the LED 52 or other means for light generation if replacement is needed. LED's 52 would be the preferred means for light generation due to their low power consumption, high light output, low heat, and long life. As noted, all the parts of the socket assembly 34 are made of a translucent material to better diffuse the concentrated light from the LED 52 but could be transparent if less diffusion is desired for some reason.

In the event that covering of the cord 14 is desired and additional light transmission and diffusion is desirable, a preferred mode of the device 10 places one or more spacer beads 58 between adjacent light fixtures 12. This spacer bead 58 would best have a faceted exterior which would both absorb and retransmit light generated by the adjacent light fixtures 12. This is an optional embodiment to provide more light coverage with less cord showing but it must be understood that the light fixtures 12 could be adjacent to each other without the spacer beads 58 or that there can be one or more spacer beads 58 between the light fixtures 12 or any combination thereof, forming and lengthening the decorative string lights 10 as desired.

As noted above the current best means for light generation is an LED 52 because of the aforementioned characteristics. However, the inverted mounting of any means for light generation such as a light bulb or mini light inside a translucent socket assembly 34 and surrounded by the decorative casing 28 would still yield a significant enhancement in decorative lighting by providing a string of lights with very even light transmission on all surfaces of the surrounding casing 28 and eliminating dark spots or sides as is a significant problem with conventional decorative string lights. As such, the use of other means for light generation are anticipated.

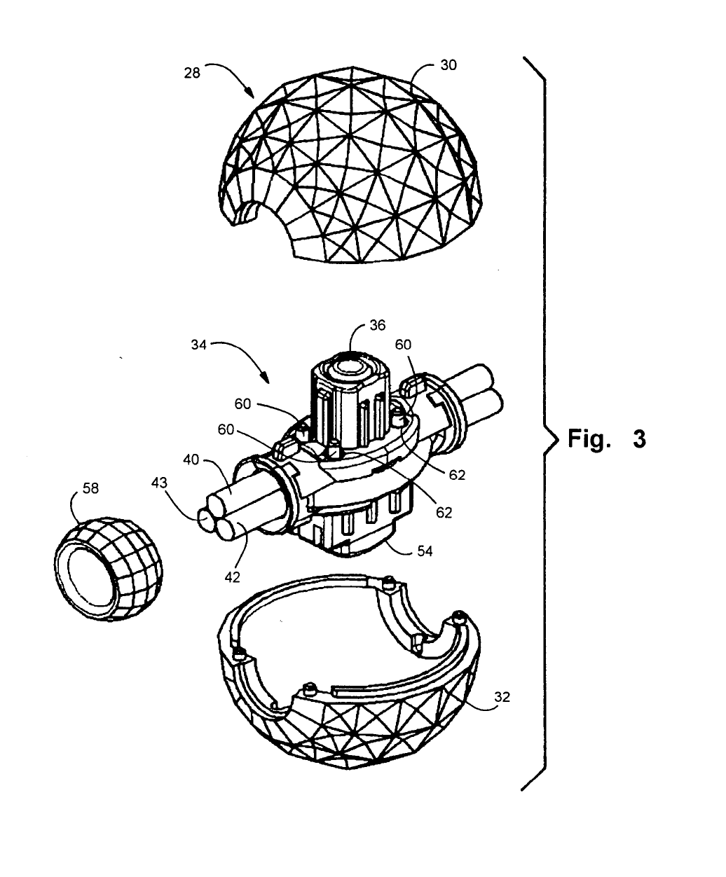

FIG. 3 further depicts a perspective view of the decorative string lights 10 having light fixture 12 with the translucent socket assembly 34 assembled for even light transmission from the centrally located LED 52 in its inverted mount. The two halves of the socket assembly are held together by a means for cooperative engagement of the upper section 36 to the lower section 38 which is depicted as the four locating and locking fixtures 60 protruding through orifices 62. However, those skilled in the art will no doubt realize that other means for cooperative engagement of upper section 36 to the lower section 38 can be used and such are anticipated. Since it is highly probably that the light source inside may need replacement, the best means for cooperative engagement would allow for disengagement of the two halves. However, due to the long life span of LED's, the device 10 could be manufactured with a permanent engagement of the two halves if a bit less utility is all that is required.

FIG. 4 is a schematic depicting a preferred mode of the current limit circuit 64 which in the current best mode is placed inside the male plug 20 in order to limit the current downstream on interconnecting wire 40. The current limit system has two modes of operation. The first mode is the charging of a storage device, in this case a capacitor labeled C1. The second mode is the delivering of a fixed amount of power to the LED's when they are illuminating.

The circuit is thus a means to limit the total power communicated to the LED's during each AC cycle or oscillation whereby each cycle a certain amount of power is supplied to the LEDs. If the voltage communicated to the circuit 64 from the AC source goes higher, the current communicated would also be higher, but the current is shut off faster by the circuit 64 to thus limit the total power communicated to the LED's or other means for illumination that are wired on the interconnecting wire 40. In instances where the voltage from the AC power supply goes down or is reduced, the current communicated through the circuit 64 to the LED's or light emitting means on the interconnecting wire 40 is lower, and to make the power communicated within the desired upper and lower limits the amount of time the current is delivered to the LED'S in the circuit is increased. This timing of the current and voltage balances the power per cycle and therefore the dissipation and provides a mean to provide balanced power per cycle to the LED's 52 or other means for light emission at a predetermined power level to match the ability of the LED's or other means for light emission's requirements and also prevent burn outs. It thus provides a means to limit the total electrical power communicated to the LED's 52 between a predetermined minimum and maximum power level depending on the number and voltage of the LED's which have power communicated to them through the circuit 64.

In operation the circuit 64 functions as AC current reverses the voltage on two wires each half cycle. Therefore the Voltage at J3 alternates with respect to J1 being positive during one half cycle (first mode) and negative during the other half cycle (second mode) as would the voltage downstream at J2 and J4 respectively. The operation during the first mode is very simple. The diode D6 conducts current as soon as the voltage rises above about 0.6V. The current increases through R4 and charges C1 to a voltage limited by D9. Therefore D9 establishes the amount of power stored on C1.

The operation during the second mode is a little more complex. When the voltage on J1 is positive enough to exceed the voltage drop required by the LED devices to allow them to conduct, the current limit comes into play. Because the voltage established on C1 is present it turns on Q1. The current flows through Q1 and R1 to the LED's. As the current increases the voltage drop increases across R1. This voltage drop allows R3 to discharge C1. The amount of discharge is determined by the amount of power being applied to the LED chain. When the power stored on C1 has been drained off by R3 enough, Q1 stops conducting. The process repeats on the next cycle.

Since J1 connects directly to J2 and J3 connects directly to J4, a downstream string plugging into the female plug 20 would receive AC power substantially equal in voltage and amperage to that available at J1 and J3. Thus a downstream string of lights would use its own current limit circuit 24 to run the LED's 52 as would a string downstream from that string.

An alternate embodiment of the decorative string lights 10 with the LED's 53 or other means for light emission or generation mounted inverted inside the upper section 36 and lower section 38, would be operated by a low voltage circuit using a conventional transformer. While not the most preferred mode of the device it would allow for the mounting of the inverted light source and use of low power components. A second alternate embodiment of the decorative string lights 10 could also be operated with a conventional battery or 12 volt DC power supply. This would be especially useful for mounting on vehicles where DC power is readily available and still yield the enhanced light projection and illumination provided by the inverted mount of the light emission devices or LED's 50.

The decorative string lights shown in the drawings and described in detail herein disclose arrangements of elements of particular construction and configuration for illustrating preferred embodiments of structure and method of operation of the present invention. It is to be understood, however, that elements of different construction and configuration and other arrangements thereof, other than those illustrated and described may be employed for providing decorative string lights in accordance with the spirit of this invention, and such changes, alternations and modifications as would occur to those skilled in the art are considered to be within the scope of this invention as broadly defined in the appended claims.

What is claimed is:

1. A decorative string light, comprising:
a power chord adapted at a first end for engagement with an AC power source;
at least one socket assembly connected to said power chord, said socket assembly having a top wall, a bottom wall, a center cavity, and sidewalls;
said center cavity dimensioned for mounting an electric means for light emission therein in a mounted position;
means to communicate electrical power from said power chord, to said electric means for light emission when in said mounted position; and
said socket assembly composed of substantially transparent or translucent material wherein light generated by said means for light emission is diffused and transmitted and through said top wall, said bottom wall, and said sidewalls.

2. The decorative string light of claim 1 further comprising:
said means for light emission being an LED;
said means to communicate electrical power from said power chord being a pair of wires communicating between said power chord and said LED; and
circuit means to limit said total electrical power communicated to said LED during each AC cycle, between a predetermined minimum power level and maximum power level.

3. The decorative string light of claim 2 additionally comprising:
said top wall of said socket assembly removably engaged with said socket assembly.
a plurality of electrical contacts communicating electrically connected to the power cord;
each of said pair of wires communicating between said one of said electrical contacts and said LED; and
said LED removably engaged in an inverted position in said center cavity when in said mounted position, whereby said top wall may be removed and said LED replaced.

4. The decorative string light of claim 2 additionally comprising:
a casing attached to said socket assembly; and
said casing formed of a wall of substantially transparent or substantially translucent material, said material allowing light transmitted from said LED through said socket assembly to transmit through said casing.

5. The decorative string light of claim 3 additionally comprising:
a casing attached to said socket assembly; and
said casing formed of a wall of substantially transparent or substantially translucent material allowing light communicated from said LED through said socket assembly to transmit through said casing.

6. The decorative string light of claim 4 additionally comprising:
said casing having an upper section and a lower section;
said upper section removably engageable with said lower section; and
means for light diffusion formed in said wall forming said casing thereby diffusing light communicated from said LED through said socket assembly.

7. The decorative string light of claim 5 additionally comprising:
said casing having an upper section and a lower section;
said upper section removably engageable with said lower section; and
means for light diffusion formed in the wall of said casing thereby diffusing light communicated from said LED through said socket assembly.

8. A decorative string light, comprising:
a power chord adapted at a first end for engagement with an AC power source;
said power chord having a first wire, a second wire, and a having third wire communicating between said first wire and said second wire;
at least one socket assembly attached to said third wire, said socket assembly having a top wall, a bottom wall, a center cavity, and sidewalls;
electric means for light emission;
said center cavity dimensioned for mounting said electric means for light emission therein in a mounted position;
means to communicate electrical power from said third wire, in series, through said electric means for light emission when in said mounted position; and
said socket assembly composed of substantially transparent or translucent material, wherein light generated by said means for light emission is transmitted and through said top wall, said bottom wall, and said sidewalls.

9. The decorative string light of claim 8, additionally comprising:
a casing attached to said socket assembly; and
said casing formed of a wall, said wall substantially surrounding said socket assembly and formed of substantially transparent or substantially translucent material, said wall diffusing light transmitted from said LED through said socket assembly, when transmitted through said casing.

10. The decorative string light of claim 8 further comprising:
said means for light emission being an LED;
said means to communicate electrical power from said third wire, in series, through said electric means for light emission, being said LED electrically communicating in series between gaps in said third wire; and
circuit means to limit said total electrical power communicated through said LED wired in series with said third wire, during each AC cycle, between a predetermined minimum electrical power level and maximum electrical power level.

11. The decorative string light of claim 9 further comprising:
said means for light emission being an LED;
said means to communicate electrical power from said third wire, in series, through said electric means for light emission, being said LED electrically communicating in series between gaps in said third wire; and
circuit means to limit said total electrical power communicated through said LED wired in series with said third wire, during each AC cycle, between a predetermined minimum electrical power level and maximum electrical power level.

12. The decorate string light of claim 10 further comprising:
said LED being inverted in said mounted position.

13. The decorate string light of claim 11 further comprising:
said LED being inverted in said mounted position.

14. The decorate string light of claim 10 additionally comprising:
said least one socket assembly attached to said third wire with said first and second wires fractionally engaged on said side walls; and
said third wire communicating with a plurality of electrical contacts adapted to engage said LED in a series electrical connection with said third wire whereby light transmitted from said LED through said top wall, and said bottom wall, and portions of both sidewalls, is unimpeded by said first wire and said second wire.

15. The decorate string light of claim 11 additionally comprising:
said least one socket assembly attached to said third wire with said first and second wires fractionally engaged on said side walls; and
said third wire communicating with a plurality of electrical contacts adapted to engage said LED in a series electrical connection with said third wire whereby light transmitted from said LED through said top wall, and said bottom wall, and portions of both sidewalls, is unimpeded by said first wire and said second wire.

16. The decorate string light of claim 12 additionally comprising:
said least one socket assembly attached to said third wire with said first and second wires fractionally engaged on said side walls; and
said third wire communicating with a plurality of electrical contacts adapted to engage said LED, in an inverted position in said center cavity in a series electrical connection with said third wire whereby light transmitted from said LED through said top wall, and said bottom wall, and portions of both sidewalls, is unimpeded by said first wire and said second wire.

17. The decorate string light of claim 13 additionally comprising:
said least one socket assembly attached to said third wire with said first and second wires fractionally engaged on said side walls; and
said third wire communicating with a plurality of electrical contacts adapted to engage said LED in an inverted position in said center cavity in a series electrical connection with said third wire whereby light transmitted from said LED through said top wall, and said bottom wall, and portions of both sidewalls, is unimpeded by said first wire and said second wire.

18. The decorative string light of claim 14 additionally comprising:
a locking plug engaged through said bottom wall;
said locking plug maintaining said led in said series electrical connection with said electrical contacts attached to said third wire; and
said LED removable by removing said locking plug, whereby said LED may be removed and replaced by removing said locking plug and inserting a replacement LED and re engaging said locking plug.

19. The decorative string light of claim 15 additionally comprising:
a locking plug engaged through said bottom wall;
said locking plug maintaining said led in said series electrical connection with said electrical contacts attached to said third wire; and
said LED removable by removing said locking plug, whereby said LED may be removed and replaced by removing said locking plug and inserting a replacement LED and re engaging said locking plug.

20. The decorative string light of claim 16 additionally comprising:
a locking plug engaged through said bottom wall;
said locking plug maintaining said LED inverted in said mounted position and in said series electrical connection with said electrical contacts attached to said third wire; and
said LED removable by removing said locking plug, whereby said LED may be removed and replaced by removing said locking plug and inserting a replacement LED and re engaging said locking plug.

21. The decorative string light of claim 17 additionally comprising:
a locking plug engaged through said bottom wall;
said locking plug maintaining said LED inverted in said mounted position in said series electrical connection with said electrical contacts attached to said third wire; and
said LED removable by removing said locking plug, whereby said LED may be removed and replaced by removing said locking plug and inserting a replacement LED and re engaging said locking plug.

22. The decorative string lights of claim 2 additionally comprising:
said circuit means to limit said total electrical power communicated through said LED wired in series with said third wire, during each AC cycle, between a predetermined minimum electrical power level and maximum electrical power level comprises:
means to interrupt current flow in proportion to the voltage communicated through said third wire and said LED in series, for durations of time during each AC cycle, to limit said total electrical power communicated through said LED between a minimum power level and a maximum power level; and
said means to interrupt current flow interrupting said current flow during each AC cycle for longer durations when said voltage is higher and shorter durations when said voltage is lower, to thereby limit said total power communicated through said LED from said third wire.

23. The decorative string lights of claim 10 additionally comprising:
said circuit means to limit said total electrical power communicated through said LED wired in series with said third wire, during each AC cycle, between a predetermined minimum electrical power level and maximum electrical power level comprises:
means to interrupt current flow in proportion to the voltage communicated through said third wire and said LED in series, for durations of time during each AC cycle, to limit said total electrical power communicated through said LED between a minimum power level and a maximum power level; and
said means to interrupt current flow interrupting said current flow during each AC cycle for longer durations when said voltage is higher and shorter durations when said voltage is lower, to thereby limit said total power communicated through said LED from said third wire.

24. The decorative string lights of claim 4 additionally comprising:
at least one spacer positioned upon said power chord between each socket assembly and any adjacent socket assembly; and
said spacer adapted to receive light transmitted from said casings mounted upon adjacent socket assembles and retransmit said light.

25. The decorative string lights of claim 9 additionally comprising:
at least one spacer positioned upon said power chord between each socket assembly and any adjacent socket assembly; and
said spacer adapted to receive light transmitted from said casings mounted upon adjacent socket assembles and retransmit said light.
